(19) United States
(12) Patent Application Publication
(10) Pub. No.: US 2004/0260934 A1
(43) Pub. Date: Dec. 23, 2004

(54) Memory chip having an integrated address scrambler unit and method for scrambling an address in an integrated memory

(76) Inventors: Manfred Proll, Dorfen (DE); Ralf Schneider, Munchen (DE); Tobias Hartner, Hamburg (DE); Evangelos Stavrou, Munchen (DE)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/841,545

(22) Filed: May 10, 2004

(30) Foreign Application Priority Data
May 19, 2003 (DE) 10322541.2

(51) Int. Cl. G06F 12/14

(52) U.S. Cl. 713/193; 711/163

(57) ABSTRACT

A memory chip having an integrated address scrambler unit that has address inputs for applying an address and can be to scramble the address in various ways depending on control bits. In addition, a memory cell array is provided, which is connected downstream of the address scrambler unit. This allows an increase in flexibility during scrambling.

### CROSS REFERENCE TO RELATED APPLICATIONS

This application claims priority under 35 USC §1 19(e) to German Application No. 10322541.2, filed on May 19, 2003, and titled “Memory Chip Having An Integrated Address Scrambler Unit, And Method For Scrambling An Address In An Integrated Memory,” the entire contents of which are hereby incorporated by reference.

### FIELD OF THE INVENTION

The invention relates to a memory chip having an integrated address scrambler unit, and to a method for scrambling an address in an integrated memory.

### BACKGROUND

To analyze a faulty memory cell in a memory cell array physically or to write particular patterns, also referred to as scramble patterns, to the memory cell array for test purposes, the actual arrangement of the memory cells in the memory chip does not concur with the idea of an ideal matrix. The memory chip is normally not square. Secondly, attempts are made to accommodate as many memory cells as possible on as small an area as possible and to be able to address these memory cells with the shortest possible time delays. In other words, the logistics required for writing data to particular memory cells or reading data therefrom necessitates that the addressing be split as cleverly as possible.

To obtain the physical position of an addressed memory cell a special program or address decoding is necessary to scramble the address. Scrambling means that an address is converted such that a defined memory cell is addressed in the memory chip. However, this means that it is necessary to connect a different address to the address lines in the memory chip than that which one wants to address logically.

To check and ensure that a memory chip is operational, it is necessary to find critical conditions which are relevant to the respective memory chip. These conditions take into account physical effects which can sometimes restrict or impair the operation of the memory. Such effects may be, for example, unwanted electrical coupling between adjacent bit or word lines or between the memory cells, for instance, the capacitor unit cells, in a dynamic semiconductor memory or the stray magnetic fields onto the memory cells in a ferromagnetic random access memory (MRAM), which are, for example, in the form of exchange-coupled magnet unit cells.

An important prerequisite for addressing such effects directly is suitable addressing of the appropriate areas, e.g., a memory cell, in the memory cell array. The actual location, for example the location of a memory cell in the memory cell array, for example, the physical address (x0, y0) and the x and y coordinates of the row and column decoder in the memory, such as the logical address (x, y), are normally not congruent. To be able to set up a unique association between logical and physical addresses, it is necessary to define a function which is adopted by a “scrambler”. The scrambling of the addresses can often be a very complex mathematical operation which needs to be programmed in an external test system, for instance, one which is outside of the memory. The different design or the different ratio of chip area to memory size, for example, mean that the memory chips' scrambling differs.

To date, as FIG. 1 shows, the address scrambling has been programmed outside of the memory chip 20 using a test system 10 with a virtual memory cell array 1 1. While the test is running, with the test system prescribing the clock clk, the data d, the address adr and the control commands ctr, the memory cell array 21 in the memory chip 20 covers a trajectory, e.g., in the form of a full translation in the x direction and then in the y direction, or, for example, in the form of a diagonal etc. For every step in the test sequence, the address scrambler 10 is polled and outputs the appropriate physical coordinates.

The problem in this context is that programming address scramblers is complex and often entails incorrect implementation of the correct address topology in a test. Since it is usually necessary to scramble not only the addresses but also the data using a data scrambler, the complex scramblers may additionally entail some limitations on the test system and may restrict the flexibility during programming.

If various test systems are used, then it is also necessary to program the scramblers in different ways.

### SUMMARY

A memory chip having an integrated address scrambler unit can include address in an integrated memory, in which the complex programming of an external scrambler can be dispensed with and also a high level of flexibility is ensured for the way in which the address and the data are scrambled, is desirable.

A memory chip having an integrated address scrambler unit can include address inputs for applying an address and can be operated such that the address scrambler unit can be used to scramble the address in various ways depending on control bits. In addition, a memory cell array can be connected downstream of the address scrambler unit.

A method for scrambling an address in an integrated memory can include a control command to prompt an address scrambler unit provided in the memory to select one scramble pattern from a plurality of possible scramble patterns and to use this pattern for scrambling. The address to be scrambled can be supplied to the address scrambler unit and can be scrambled in line with the selected scramble pattern. Finally, the scrambled address can be supplied to a memory cell array provided in the memory.

In one embodiment of the memory chip having an integrated address scrambler unit, the address scrambler unit can have a plurality of predefined scramblers which can be operated such that the address can thus be scrambled differently depending on the control bits.

In another embodiment of the memory chip, one of the predefined scramblers can have a conversion element for converting a bit of the address and a multiplexer which can forward either the bit converted by the conversion element or the unscrambled bit.

In another embodiment of the memory chip, another of the predefined scramblers can have a further conversion element for converting an address bit of the address and a multiplexer which can forward either the address bit converted by the further conversion element or the address bit produced by one of the other predefined scramblers. Using such a combination of a plurality of predefined scramblers, it is possible to increase the number of possible scramble patterns without significantly increasing the complexity of the address scrambler unit integrated in the memory chip.

The address scrambler unit may also have a programmable scrambler. The programmable scrambler can operate such that the address can thus be scrambled in various ways depending on the control bits. Such a programmable scrambler can be used to increase the flexibility during scrambling further.

The programmable scrambler in the inventive memory chip can have a plurality of multiplexers whose input side can be connected to a plurality of the address inputs. The programmable scrambler can also have a conversion unit which produces scrambled address bits from particular bits of the address and the bits supplied by the multiplexers. The control bits can be used to control the multiplexers.

In addition, the conversion element in the inventive memory chip may have an XOR gate whose input side can be connected to a first and to a second address line.

The control bits in the memory chip be able to be prescribed externally via a control connection. This makes it possible to set the desired scramble pattern externally at any time.

The memory chip may be in a form such that the address scrambler unit can be activated using an external signal.

The method for scrambling an address in an integrated memory, the memory can be put into a test mode before the address is scrambled.

### BRIEF DESCRIPTION OF THE FIGURES

The invention is explained in more detail below using a plurality of exemplary embodiments with reference to the following figures:

FIG. 1 shows the connection of an external address scrambler to an integrated memory chip in line with the prior art.

FIG. 2 shows the basic design of an integrated semiconductor memory chip having an integrated address scrambler unit in line with the invention in the form of a block diagram.

FIG. 3 shows a possible embodiment of an address scrambler unit integrated in the memory chip in the form of a block diagram.

FIG. 4 shows a 2:1 multiplexer which can be used, for example, in the address scrambler unit shown in FIG. 3.

FIG. 5 shows an exemplary embodiment of an address scrambler unit having two predefined scramblers which are connected in line with the embodiment shown in FIG. 3.

FIG. 6 shows another possible embodiment of the address scrambler unit integrated in the memory chip.

FIG. 7 shows an example of the design of a 4:1 multiplexer.

### DETAILED DESCRIPTION

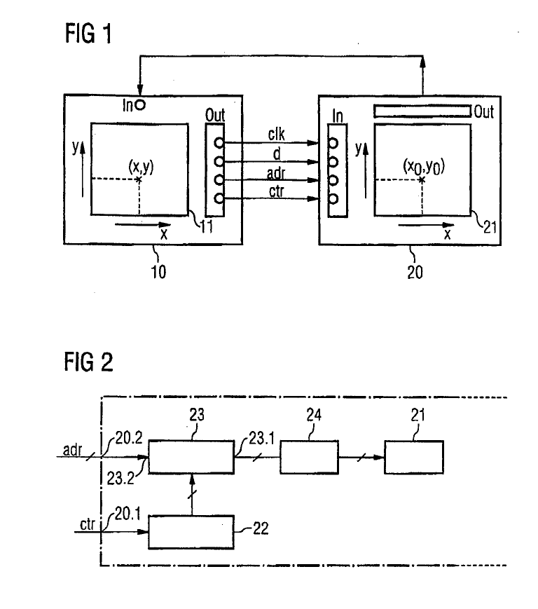

FIG. 2 shows a memory chip in the form of a block diagram. The memory chip 20 can have a series of address inputs 20.2 for applying an address adr, the address inputs 20.2 being connected internally to inputs 23.2 on a scrambler decoder 23. The scrambler decoder 23 can be controlled via, for example, a 4 bit line by a programmable scrambler or a plurality of predefined scramblers 22. To control the preprogrammable scrambler or the predefined scramblers 22, in turn, the memory chip 20 can have a control input 20.1 via which a control signal ctr can be applied. In this case, the control input 20.1 of the memory chip 20 may not require an additional connection pin for controlling the programmable scrambler or the predetermined scramblers 22, but instead may be an already existing connection pin which can be used to control the address scrambler unit 22, 23, besides other functions. The control signal ctr can be used to select the desired scramble pattern from a series including a plurality of different possible scramble patterns, and the scrambler decoder 23 can be used to scramble the address adr accordingly. The output of the scrambler decoder 23.1 can then produce the scrambled address, which can subsequently be fed via an address decoder 24 to a conventional memory cell array 21 in the memory chip 20. If the address scrambler unit 22, 23 is not activated by the control signal ctr, this means that the memory chip 20 is operated conventionally. The address adr can be fed unscrambled to the address decoder 24, which then decodes it and feeds it to the memory cell array 21.

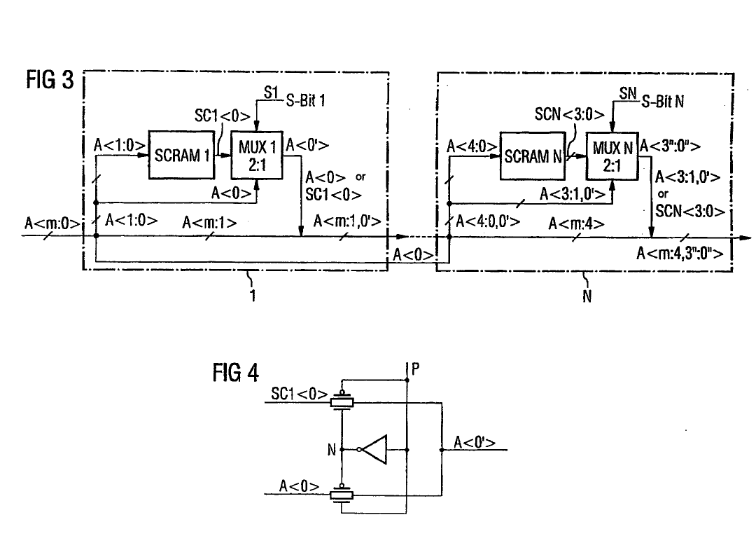

FIG. 3 shows one possible embodiment of an address scrambler unit having N predefined scramblers 1 to N. In this case, an address A<m:0> including m+1 bits in total can be supplied to the address scrambler unit. Two bits thereof, for example, the bit A<1> and the bit A<0> are fed to a first conversion unit SCRAM 1, which calculates a scrambled bit SC 1<0> therefrom and can feed it to a first input on a multiplexer MUX 1. The second input of the multiplexer MUX 1, which can be, for example, in the form of a 2:1 multiplexer, can have the bit A<0> applied to it. A first control bit S1 can now be used to select whether the original address bit A<0> or the scrambled address bit SC1<0> can be fed to the output of the multiplexer MUX 1 as an address output bit A<0′>. Using the first predefined scrambler 1, the original address A<m:0> can be scrambled into the scrambled address A<m:1,0′>, if the control bit S1 has been set. Otherwise, the original address A<m:0> can be retained.

Depending on the instance of application and requirements, the integrated memory chip 20 may contain a plurality of scramblers predefined in this manner. This is indicated in FIG. 3 by a further, Nth predefined scrambler N. Unlike the first predefined scrambler 1, the further predefined scrambler N, for example, as in FIG. 3, can also use the conversion unit SCRAM N to scramble a plurality of bits of the address A<m:0>, for example the bits A<4:0>. The output of the conversion unit SCRAM N then produces scrambled address bits SCN<3:0>, which are fed to the multiplexer MUX N. Using the Nth control bit SN, whether the multiplexer MUX N carries either the scrambled address bits SCN<3:0> or the address bits A<3:1,0′> as address output bits A<3″:0′> can be determined.

FIG. 4 shows one possible embodiment of a 2:1 multiplexer at transistor level. The multiplexer MUX 1 from FIG. 3 can be in this form, for example. In this case, the connection P corresponds to the control input of the multiplexer MUX 1, which can be controlled with the control bit S1.

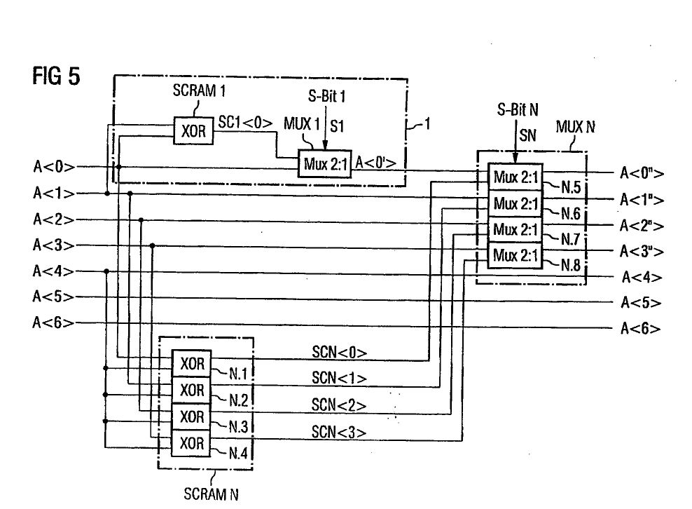

FIG. 5 shows a more detailed illustration of a possible embodiment of the address scrambler unit from FIG. 3. The conversion unit SCRAM 1, which may be used, can be an XOR gate, for example, whose two inputs can be connected to the address lines A<0> and A<1>. At the output of the XOR gate SCRAM 1, it is then possible to take the scrambled address bit SC1<0>, which can be fed to the first input of the multiplexer MUX 1. The second input of the multiplexer MUX 1 can be by contrast, connected to the original address line A<0>. The output A<0′> of the multiplexer MUX 1 can be fed to the input of a 2:1 multiplexer N.5, which can be part of the multiplexer MUX N. The address lines A<0>, A<1>, A<2>, A<3> and A<4>, as is shown in FIG. 5, are fed to four XOR gates N.1 to N.4, which together form the conversion unit SCRAM N. The outputs SCN<0> to SCN<3> of the latter are fed to the inputs of the 2:1 multiplexers N.5-N.8. In addition, the address lines A<1>, A<2> and A<3> are also fed to the inputs of the multiplexers N.6, N.7 and N.8. As can also be seen from FIG. 5, the address bits A<0>, A<1>, A<2> and A<3> can be scrambled based on the control bits S1 and SN, whereas the address bits A<4>, A<5> and A<6> can remain unscrambled.

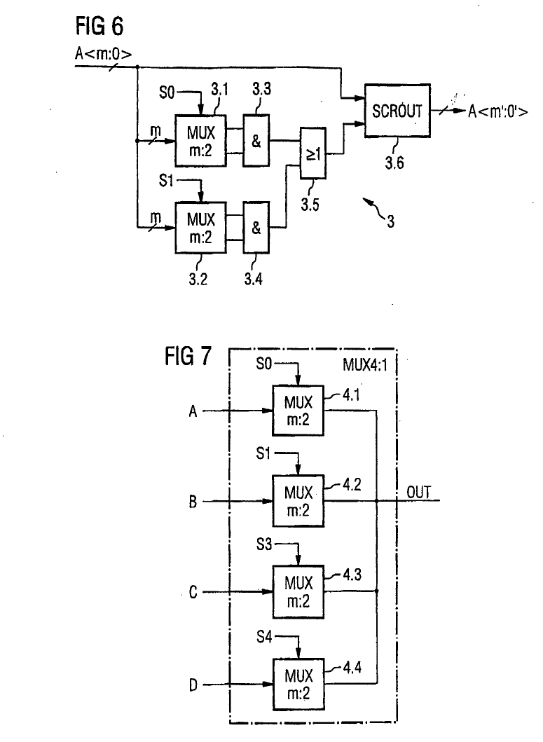

FIG. 6 shows another embodiment of the address scrambler unit. In this context, a programmable scrambler 3 can be used. Using a conversion unit 3.6, the address bits A<m:0> can be combined with those from the two multiplexers 3.1 and 3.2 and also the downstream AND gates 3.3 and 3.4 and the OR gate 3.5, and are supplied as scrambled output bits A<m′:0′> to the address decoder 24 shown in FIG. 2. The two control bits S0 and S1 can be used to program the programmable scrambler 3. As a result, various scramble patterns which can then be used to scramble the address adr in various ways, can be produced.

The conversion unit 3.6 can be in the form of an XOR gate, for example. If, in this case, the bit at the output of the OR gate 3.5 has been set to the logic state 1, all of the address bits A<m:0> can be inverted in the conversion unit 3.6.

The programmable scrambler 3 is not limited to the embodiment shown for example in FIG. 6, but rather may also have further multiplexers and appropriately downstream combination elements without question. This makes it possible to increase the number of scramble patterns or to match it to requirements.

FIG. 7 shows one possible embodiment of a 4:1 multiplexer. The four m:2 multiplexers 4.1 to 4.4 can be controlled four control bits S0 to S4.

Thus, addresses and data can be scrambled, using various scramble patterns.

The above description of the exemplary embodiments in line with the present invention serves merely for illustrative purposes and not to limit the invention. The invention allows various changes and modifications without departing from the scope of the invention and its equivalents.

List Of Reference Symbols

| | |
|---|---|
| 1 | First predefined scrambler |
| N | Nth predefined scrambler |
| 3 | Programmable scrambler |
| N.1-N.4 | Conversion units |
| 3.1 | Multiplexer |
| 3.2 | Multiplexer |
| 3.3 | AND gate |
| 3.4 | AND gate |
| 3.5 | OR gate |
| 3.6 | Conversion unit |
| 4.1-4.4 | m:2 multiplexer |
| 10 | Test system |
| 11 | Virtual memory cell array |
| 20 | Memory chip |
| 20.1 | Control connection |
| 20.2 | Address inputs |
| 21 | Physical memory cell array |
| 22 | Scrambler |
| 23 | Scrambler decoder |
| 24 | Address decoder |
| clk | Clock |
| d | Data |
| adr | Address |
| ctr | Control signal |
| x, y | Logical address |
| x0, y0 | Physical address |
| S0, S1, SN | Control bits |
| A<m:0> | m + 1 address lines or address bits |
| SCRAM1 | Conversion unit |
| MUX | Multiplexer |
| A<0>-A<6> | Address lines or address bits 1 to 6 |
| SC<0> | Scrambler output |
| SCN<0> | Output on the Nth scrambler |
| A0′, A0″ | Address bit at the output of the scrambler |

We claim:

1. A memory chip, comprising:
an integrated address scrambler unit, the address scrambler unit having a plurality of address inputs for applying an address, the address scrambler unit designed to scramble the address depending on control bits; and
a memory cell array, the memory cell array beams connected downstream of the address scrambler unit.

2. The memory chip as claimed in claim 1, wherein the address scrambler unit has a plurality of predefined scramblers, the predetermined scramblers designed such that the address can be scrambled differently depending on the control bits.

3. The memory chip as claimed in claim 2, wherein one of the predefined scramblers has a first conversion element for converting a bit of the address and a first multiplexer for forwarding either the bit converted by the conversion or the unscrambled bit depending on one of the control bits.

4. The memory chip as claimed in claim 3, wherein a second of the predefined scramblers has a second conversion element for converting an address bit of the address and a second multiplexer for forwarding either the address bit converted by the second conversion element or the address bit produced by one of the other predefined scramblers depending on one of the control bits.

5. The memory chip as claimed in claim 1, wherein the address scrambler unit has a programmable scrambler, the programmable scrambler designed such that the address can be scrambled depending on the control bits.

6. The memory chip as claimed in claim 5, wherein the programmable scrambler has a plurality of multiplexers whose input side is connected to a plurality of the address inputs, the programmable scrambler has a conversion unit which produces scrambled address bits from particular bits of the address and the bits supplied by the multiplexers, the control bits being used to control the multiplexers.

7. The memory chip as claimed in claim 3, wherein the conversion element has an XOR gate whose input side is connected to a first address line and to a second address line.

8. The memory chip as claimed in claim 1, wherein the control bits can be prescribed externally via a control connection.

9. The memory chip as claimed in claim 1, wherein the address scrambler unit can be activated using an external signal.

10. A method for scrambling an address in an integrated memory comprising:
a control command to prompt an address scrambler unit, the address scrambler unit being provided in the memory to select one scramble pattern from a plurality of scramble patterns for use in scrambling;
supplying the address to be scrambled is to the address scrambler unit;
scrambling the address using the address scrambler unit; and
supplying the scrambled address to a memory cell array provided in the memory.

11. The method as claimed in claim 10, further comprising: testing the memory before scrambling the address.

12. The memory chip as claimed in claim 5, wherein the conversion element has an XOR gate whose input side is connected to a first address line and to a second address line.
